(19) United States
(12) Patent Application Publication
(10) Pub. No.: US 2014/0146236 A1
(43) Pub. Date: May 29, 2014

(54) CALCULATING APPARATUS, CALCULATING METHOD, AND NON-TRANSITORY COMPUTER-READABLE STORAGE MEDIUM STORING COMPUTER-EXECUTABLE INSTRUCTIONS

(71) Applicant: Kabushiki Kaisha Toshiba, Tokyo (JP)

(72) Inventor: Akihiro Oue, Ome-shi (JP)

(73) Assignee: Kabushiki Kaisha Toshiba, Tokyo (JP)

(21) Appl. No.: 13/947,946

(22) Filed: Jul. 22, 2013

(30) Foreign Application Priority Data
Nov. 29, 2012 (JP) 2012-261264

(51) Int. Cl. H04N 5/14

(52) U.S. Cl. CPC H04N 5/14
USPC 348/720

(57) ABSTRACT

According to one embodiment, a calculating apparatus includes, a register module includes a plurality of registers configured to store a plurality of values, a controller configured to specify a plurality of registers including a register to which input data is written, and a calculator configured to calculate a predetermined combination of the values of the specified registers.

### CROSS-REFERENCE TO RELATED APPLICATIONS

This application is based upon and claims the benefit of priority from Japanese Patent Application No. 2012-261264, filed Nov. 29, 2012, the entire contents of which are incorporated herein by reference.

### FIELD

Embodiments described herein relate generally to a calculating apparatus, a calculating method, and a non-transitory computer-readable storage medium storing computer-executable instructions.

### BACKGROUND

There has heretofore been a generally spread electronic device such as a broadcasting receiver that is capable of receiving a broadcasting signal and reproducing video content of, for example, a program included in the received broadcasting signal. This electronic device comprises a calculator to generate a display video signal for displaying images on a display. The calculator can convert coordinates of each pixel of the display video signal by calculating a high-degree polynomial in accordance with a preset algorithm.

In order to calculate the high-degree polynomial, a plurality of commands are needed for the calculator to perform the calculation. However, a more efficient calculation of the high-degree polynomial is demanded.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing a calculating apparatus according to an embodiment.

FIG. 2 is an exemplary view showing the calculating apparatus according to an embodiment.

FIG. 3 is an exemplary view showing the calculating apparatus according to an embodiment.

FIG. 4 is an exemplary view showing the calculating apparatus according to an embodiment.

FIG. 5 is an exemplary view showing the calculating apparatus according to an embodiment.

FIG. 6 is an exemplary view showing the calculating apparatus according to an embodiment.

FIG. 7 is an exemplary view showing the calculating apparatus according to an embodiment.

FIG. 8 is an exemplary view showing the calculating apparatus according to an embodiment.

### DETAILED DESCRIPTION

Various embodiments will be described hereinafter with reference to the accompanying drawings. In general, according to one embodiment, a calculating apparatus comprises, a register module comprising a plurality of registers configured to store a plurality of values, a controller configured to specify a plurality of registers including a register to which input data is written, and a calculator configured to calculate a predetermined combination of the values of the specified registers.

A calculating apparatus, a calculating method, and a non-transitory computer-readable storage medium storing computer-executable instructions according to one embodiment will be hereinafter described in detail with reference to the drawings.

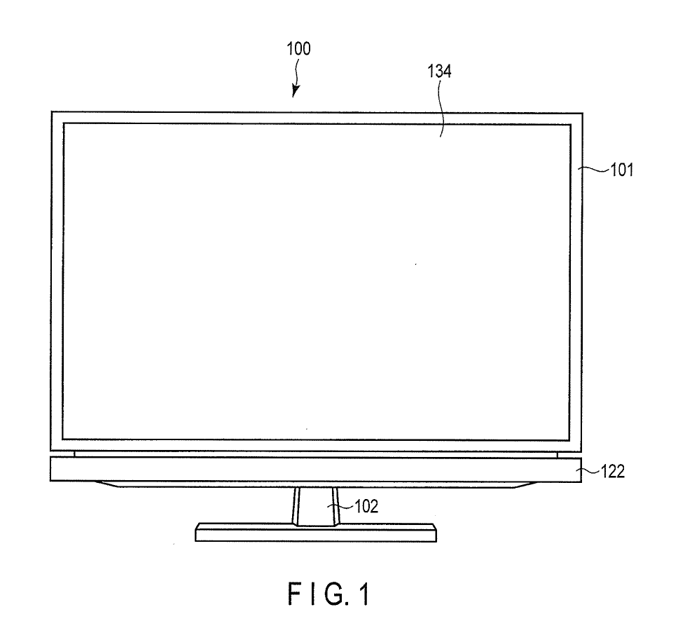

FIG. 1 shows an example of the appearance of a broadcasting receiver 100 as an electronic device according to one embodiment. The broadcasting receiver 100 comprises a body 101 provided with a display (display module) 134 to display an image, and a leg 102 which supports the body 101 so that the body 101 can stand on its own. The body 101 is also provided with a speaker 122 and others. The broadcasting receiver 100 further comprises a light-receiving module 162 capable of receiving infrared rays transmitted from a remote controller 163. The body 101 is also provided with a power switch to switch a power supply of the broadcasting receiver 100.

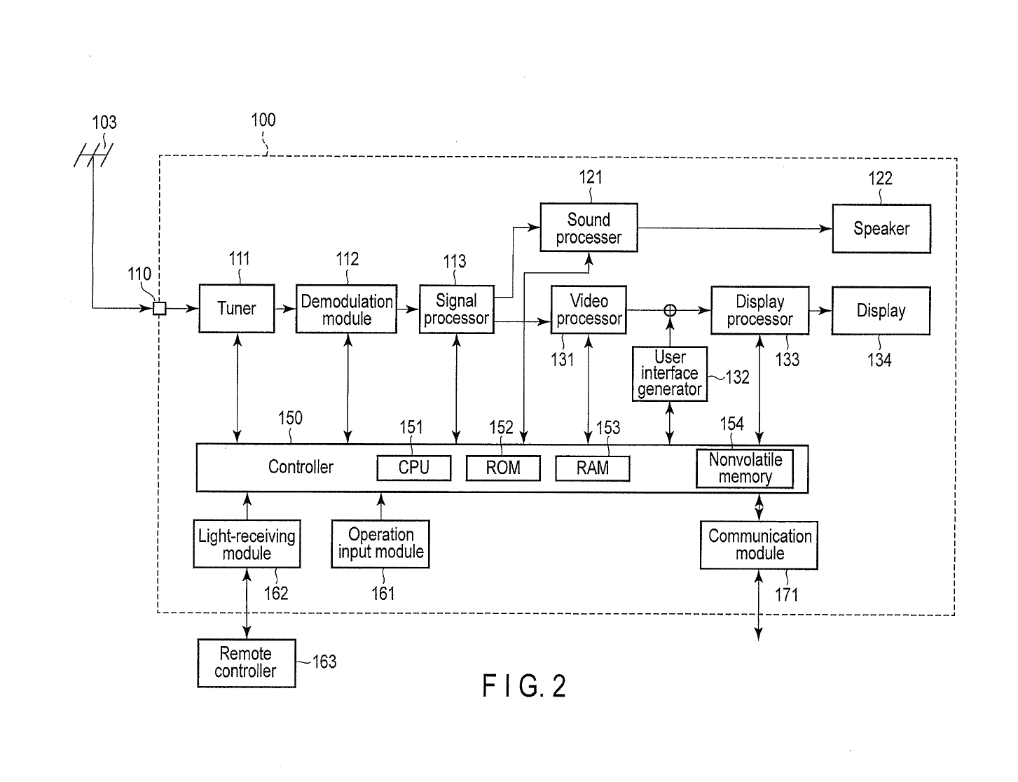

FIG. 2 shows an example of the broadcasting receiver 100 according to one embodiment.

The broadcasting receiver 100 comprises a broadcasting signal input terminal 110, a tuner 111, a demodulation module 112, a signal processor 113, a sound processor 121, a video processor 131, a user interface (UI) generator 132, a display processor 133, a controller 150, an operation input module 161, the light-receiving module 162, and a communication module 171. The broadcasting receiver 100 further comprises a speaker 122 and a display 134.

The broadcasting signal input terminal 110 can receive a digital broadcasting signal received by, for example, an antenna 103. The antenna 103 can receive, for example, a terrestrial digital broadcasting signal, a broadcasting satellite (BS) digital broadcasting signal, and/or a 110-degree communication satellite (CS) digital broadcasting signal. The broadcasting signal input terminal 110 can receive data for content such as a program supplied by the above-mentioned digital broadcasting signal.

The broadcasting signal input terminal 110 supplies the received digital broadcasting signal to the tuner 111. The tuner 111 is a tuner for the digital broadcasting signal. The tuner 111 transmits the tuned digital broadcasting signal to the demodulation module 112.

The demodulation module 112 demodulates the received digital broadcasting signal. The demodulation module 112 thereby acquires content data such as a transport stream (TS) from the digital broadcasting signal. The demodulation module 112 inputs the acquired content data to the signal processor 113. That is, the antenna 103, the tuner 111, and the demodulation module 112 function as receiving modules to receive the content data.

The signal processor 113 performs signal processing, for example, to separate the content data. That is, the signal processor 113 separates the content data into a digital video signal, a digital audio signal, and other data signals. The signal processor 113 supplies the audio signal to the sound processor 121. The signal processor 113 also supplies the video signal to the video processor 131. The signal processor 113 further supplies the data signals to the controller 150.

The sound processor 121 converts the digital audio signal received from the signal processor 113 to a signal (audio signal) in a format reproducible by the speaker 122. For example, the sound processor 121 converts the digital audio signal to an audio signal by digital/analog conversion. The sound processor 121 supplies the audio signal the speaker 122. The speaker 122 reproduces sound in accordance with the supplied audio signal.

The video processor 131 converts the digital video signal received from the signal processor 113 to a video signal (display video signal) in a format reproducible by the display 134. The video processor 131 performs rendering to generate the display video signal in accordance with the digital video signal supplied from the signal processor 113. The video processor 131 performs the rendering by various kinds of calculation processing for the digital video signal supplied from the signal processor 113. The video processor 131 outputs the rendered display video signal to the display processor 133.

The UI generator 132 generates a display video signal to display a menu screen, a browser for Web browsing, or other various kinds of information on the display 134 on the display 134 in response to a command supplied from the controller 150. The UI generator 132 superimposes the generated display video signal on the display video signal output from the video processor 131.

The display processor 133 adjusts the image quality of the received display video signal including the color, brightness, sharpness, contrast, or the like, for example, under the control of the controller 150. The display processor 133 supplies the display video signal after the image quality adjustment to the display 134. The display 134 displays an image in accordance with the supplied display video signal.

The display 134 comprises a liquid crystal display device including a liquid crystal display panel having a plurality of pixels arranged in matrix form, and a backlight which illuminates the liquid crystal display panel. The display 134 displays an image in accordance with the display video signal supplied from the display processor 133.

The controller 150 functions as a controller to control the operation of each component of the broadcasting receiver 100. The controller 150 comprises a CPU 151, a ROM 152, a RAM 153, and a nonvolatile memory 154. The controller 150 performs various kinds of processing in accordance with an operation signal supplied from the operation input module 161 or the light-receiving module 162.

The CPU 151 comprises a calculation element to perform various kinds of calculation processing. The CPU 151 executes a program stored in the ROM 152 or the nonvolatile memory 154 to enable various functions.

The ROM 152 stores programs for controlling the broadcasting receiver 100, and programs for enabling various functions. The CPU 151 starts the program stored in the ROM 152 in accordance with the operation signal supplied from the operation input module 161. The controller 150 thereby controls the operation of each component.

The RAM 153 functions as a work memory of the CPU 151. That is, the RAM 153 stores a calculation result by the CPU 151, and data read by the CPU 151.

The nonvolatile memory 154 is a nonvolatile memory to store various kinds of setting information and programs.

The controller 150 generates a command to display a user interface on the display 134. The controller 150 supplies the generated command to the UI generator 132. The controller 150 can cause the UI generator 132 to generate a user interface to be superimposed on an image.

The operation input module 161 comprises, for example, operation keys or a touch pad to generate an operation signal in response to operation input by a user. The operation input module 161 may otherwise be configured to receive an operation signal from a keyboard, a mouse, or other input devices that can generate the operation signal. The operation input module 161 supplies the operation signal to the controller 150. The touch pad includes an electric capacitance sensor, or a device which generates positional information in accordance with some other method.

The light-receiving module 162 comprises, for example, a light-receiving lens to receive infrared rays from the remote controller 163, and a sensor such as a photodiode which converts the received light to an electric signal. The light-receiving module 162 generates the original operation signal from the received infrared rays, and supplies the operation signal to the controller 150.

The remote controller 163 generates an operation signal in accordance with operation input by the user. The remote controller 163 converts the generated operation signal to infrared rays, and outputs the infrared rays. The remote controller 163 thereby transmits the infrared rays to the light-receiving module 162.

The communication module 171 can use a LAN or a wireless LAN to communicate with other devices on the Internet or a network such as a home network via a router as a wireless communication terminal. The broadcasting receiver 100 can thereby communicate with the other devices connected to the wireless communication terminal.

The broadcasting receiver 100 may further comprise a storage device such as a hard disk drive (HDD), and may be able to store, for example, a broadcasting signal or content supplied by a network in the storage device.

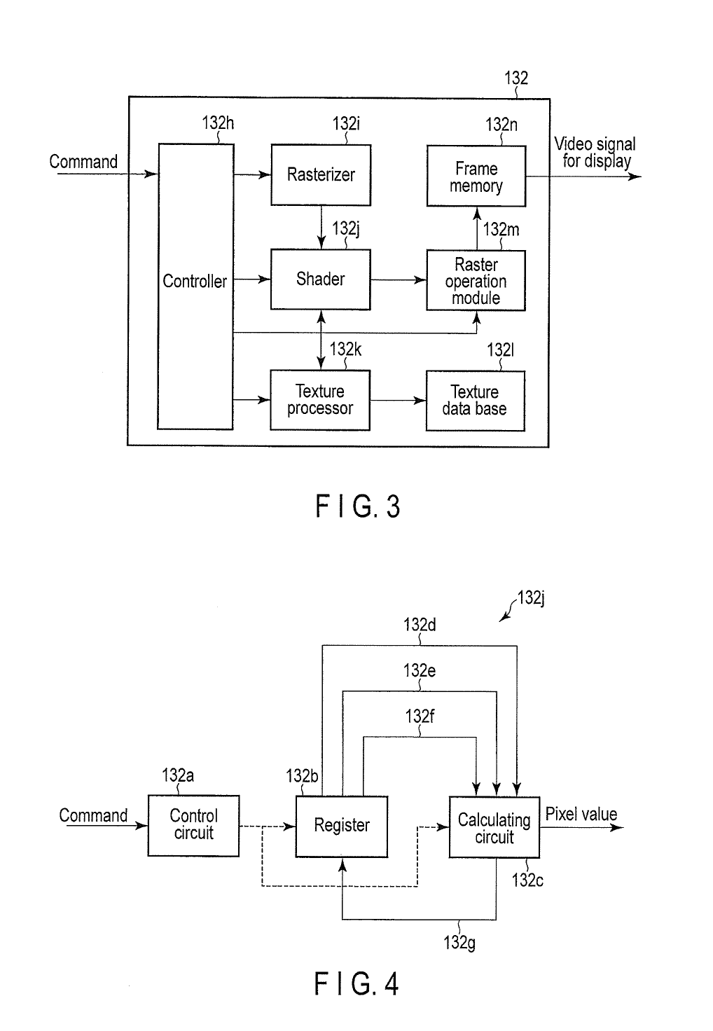

FIG. 3 shows an example of the configuration of the UI generator 132.

The UI generator 132 comprises a controller 132h, a rasterizer 132i, a shader 132j, a texture processor 132k, a texture data base 132l, a raster operation module 132m, and a frame memory 132n.

The controller 132h supplies the command supplied from the controller 150 to the rasterizer 132i, the shader 132j, the texture processor 132k, and the raster operation module 132m. The rasterizer 132i, the shader 132j, the texture processor 132k, and the raster operation module 132m performs various kinds of processing in response to the supplied command.

The rasterizer 132i breaks down the command supplied from the controller 132h into per-pixel processing. The rasterizer 132i supplies the broken command to the shader 132j. In addition, the rasterizer 132i adds data indicating the coordinates of the pixels to the broken command.

The shader 132j computes the pixel value of one pixel, for example, a color code in accordance with the command supplied from the rasterizer 132i. The shader 132j requests a texture from the texture processor 132k when necessary. The shader 132j thereby acquires the texture from the texture processor 132k. The shader 132j uses the acquired texture to compute a pixel value. The shader 132j supplies the computed pixel value to the raster operation module 132m.

The texture processor 132k reads the texture from the texture data base 132l in response to the request from the shader 132j to acquire the texture. The texture processor 132k supplies the read texture to the shader 132j. The texture processor 132k may also be configured to read the texture from the texture data base 132l in response to the command supplied from the controller 132h, and supply the read texture to the shader 132j.

The texture processor 132k filters the texture to be supplied to the shader 132j. That is, the texture processor 132k filters the texture read from the texture data base 132l, and supplies the filtered texture to the shader 132j.

The texture data base 132l can store various textures. The texture data base 132l can store, for example, a texture for each character, symbol, and numeral.

That is, the shader 132j can use the texture for each character, symbol, and numeral as input data to perform a calculation, and compute a pixel value.

The raster operation module 132m performs a raster operation for the pixel value output from the shader 132j. For example, the raster operation module 132m mixes the pixel value output from the shader 132j with the pixel value of the background to form a semitransparent state. For example, the raster operation module 132m uses a display video signal output from the video processor 131 as a background to form the pixel value output from the shader 132j into a semitransparent state. The raster operation module 132m supplies the pixel value after the raster operation to the frame memory 132n.

The frame memory 132n stores the pixel value supplied from the raster operation module 132m. The frame memory 132n can save a pixel value for a frame. When the pixel value for a frame is stored in the frame memory 132n, the frame memory 132n outputs a display video signal for a frame.

FIG. 4 shows an example of the configuration of the shader 132j.

The shader 132j comprises a control circuit 132a, a register (register module) 132b, and a calculating circuit (calculator) 132c. The shader 132j also comprises data paths 132d, 132e, 132f, and 132g to transfer data between the register 132b and the calculating circuit 132c.

The control circuit 132a is a module (controller) to control the operations of the register 132b and the calculating circuit 132c. The control circuit 132a stores the texture supplied from the texture processor 132k in a predetermined data cell (scalar register) on the register 132b.

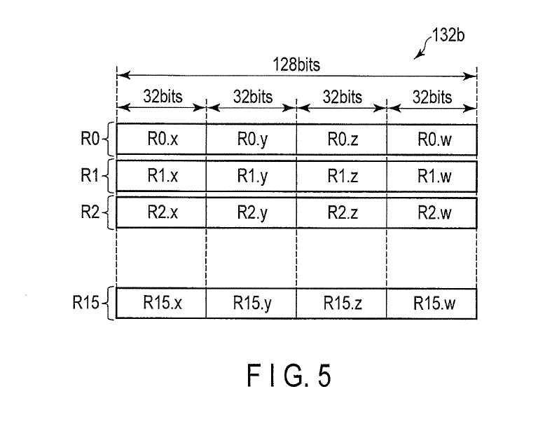

FIG. 5 shows an example of the configuration of the register 132b.

The register 132b is a module (register module) comprising a plurality of vector registers which comprise a plurality of scalar registers having a predetermined bit length. The scalar register is a register to store one value. That is, the vector register is a register capable of storing a plurality of values.

For example, the register 132b comprises a plurality of vector registers having a length of 128 bits which comprise four 32-bit scalar registers. The register 132b stores one value in one scalar register. The register 132b can write and read data for each vector register. That is, the register 132b can simultaneously read values from a plurality of scalar registers included in the vector register.

The calculating circuit 132c is a module (calculator) which performs predetermined calculation processing in accordance with data stored in the register 132b. The calculating circuit 132c can thereby compute a pixel value.

The data paths 132d, 132e, and 132f transfer data stored in one vector register within the register 132b to the calculating circuit 132c. That is, the register 132b can simultaneously transfer the data stored in the three vector registers to the calculating circuit 132c by the data paths 132d, 132e, and 132f.

The data path 132g can transfer the calculation result by the calculating circuit 132c to the register 132b. The register 132b can write the calculation result transmitted from the calculating circuit 132c by the data path 132g into one vector register or the scalar register which is a part of the vector register.

In the example of FIG. 5, the register 132b has vector registers (R0.x, R0.y, R0.z, and R0.w) having scalar registers R0.x, R0.y, R0.z, and R0.w. The register 132b further has vector registers (R1.x, R1.y, R1.z, and R1.w), (R2.x, R2.y, R2.z, and R2.w) . . . (R15.x, R15.y, R15.z, and R15.w) having a plurality of scalar registers.

Furthermore, the control circuit 132a causes the calculating circuit 132c to perform Maclaurin expansion in accordance with a command from the controller 132h or the rasterizer 132i. For example, when instructed by the command to rotate coordinates, the control circuit 132a rotate the coordinates by calculating a trigonometric function. In this case, the control circuit 132a replaces the trigonometric function with a polynomial by Maclaurin expansion to perform a calculation.

To cause the calculating circuit 132c to perform Maclaurin expansion, the control circuit 132a inputs a command MCL to the calculating circuit 132c to perform Maclaurin expansion. The control circuit 132a inputs, for example, a mnemonic command (high-degree polynomial calculation instruction) such as “MCL Ra, Rb, Rc” to the calculating circuit 132c. The control circuit 132a can thereby specify three vector registers Ra, Rb, and Rc. That is, the control circuit 132a controls the calculating circuit 132c to perform Maclaurin expansion by using the values of the three vector registers Ra, Rb, and Rc.

When the above-mentioned command is input to the calculating circuit 132c, the calculating circuit 132c reads data in the three vector registers Ra, Rb, and Rc of the register 132b from the register 132b by the data paths 132d, 132e, and 132f.

In this case, the calculating circuit 132c uses the values read from the register 132b to perform a predetermined calculation “Rc.w←Ra.x·Rc.w+Ra.y·Rb.x+Ra.z·Rb.y+Ra.w·Rb.z+Rb.w”. The calculating circuit 132c writes the calculation result of “Ra.x·Rc.w+Ra.y·Rb.x+Ra.z·Rb.y+Ra.w·Rb.z+Rb.w” into a scalar register Rc.w. The calculating circuit 132c sequentially performs the above calculation in accordance with input to compute a pixel value. That is, the calculating circuit 132c writes, into the scalar registers, the sum of the product of the values of the scalar registers in different vector registers.

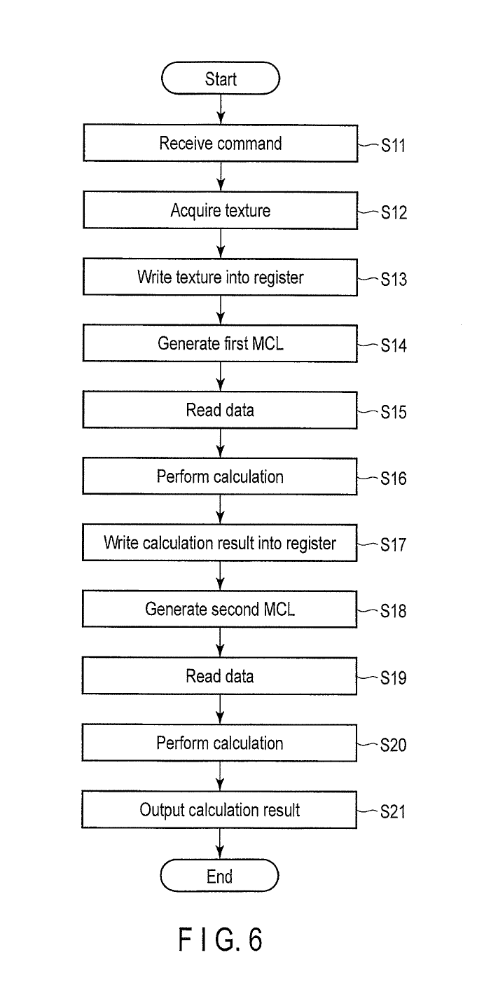

FIG. 6 shows an example of the processing in the shader 132j. The example shown here is the processing in the shader 132j when a command that requires the calculation of Maclaurin expansion is input.

The control circuit 132a of the shader 132j receives a command broken by the rasterizer 132i (step S11).

The control circuit 132a requests a texture from the texture processor 132k in response to the received command. The control circuit 132a thereby acquires the texture from the texture processor 132k (step S12).

The control circuit 132a writes the acquired texture into a predetermined scalar register on the register 132b (step S13).

The control circuit 132a generates a first MCL in response to the received command (step S14). The control circuit 132a specifies three vector registers by the first MCL. The control circuit 132a inputs the generated first MCL to the calculating circuit 132c. The control circuit 132a specifies a plurality of registers including at least a register in which input data is written.

The calculating circuit 132c reads the values of the vector registers specified by the first MCL from the register 132b (step S15). In this case, the calculating circuit 132c can read a plurality of values in a plurality of vector registers specified by the first MCL.

The calculating circuit 132c calculates a predetermined combination of the read values (step S16). The calculating circuit 132c calculates a predetermined combination of the values of a plurality of registers including the register in which the input data is written. The calculating circuit 132c also performs a calculation so that one value of the vector register is combined with the value of the vector register different from the former vector register. The calculating circuit 132c also performs a calculation so that the product of one value of the vector register and the value of the vector register different from the former vector register is one term. The calculating circuit 132c writes the calculation result into a predetermined position in the register 132b (step S17). For example, the calculating circuit 132c writes the calculation result into the scalar register of one vector register of the register 132b.

Furthermore, the control circuit 132a generates a second MCL (step S18). The control circuit 132a specifies three vector registers by the second MCL. The control circuit 132a specifies three vector registers including the vector register having the scalar register in which the calculation result is written in step S17. The control circuit 132a inputs the generated second MCL to the calculating circuit 132c.

The calculating circuit 132c reads the values of the vector registers specified by the second MCL from the register 132b (step S19). The calculating circuit 132c calculates a predetermined combination of the read values (step S20). The calculating circuit 132c outputs the calculation result as a pixel value (step S21).

As described above, the shader 132j can specify a register capable of storing a plurality of values to perform a calculation. The shader 132j can thereby calculate a polynomial with a small number of calculation instructions.

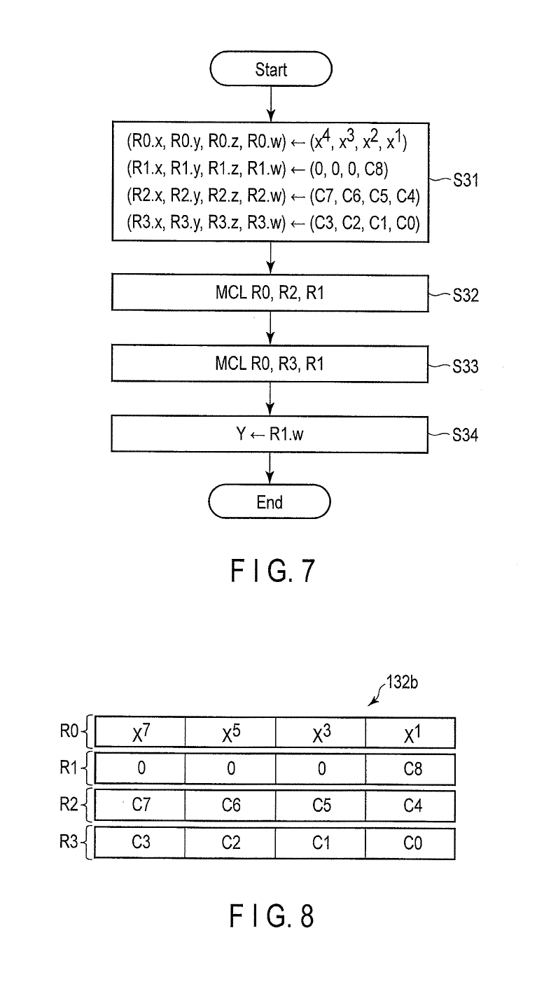

FIG. 7 shows an example of the processing in the shader 132j. The specific example shown here is the processing in the shader 132j when a command that requires the calculation of Maclaurin expansion is input.

The control circuit 132a writes data into the registers R0 to R3 (step S31). The control circuit 132a of the shader 132j receives the command broken by the rasterizer 132i. The control circuit 132a acquires a texture from the texture processor 132k. The control circuit 132a uses the acquired texture as input data X. The control circuit 132a writes (X⁴, X³, X², X¹) into the register R0.

The control circuit 132a also writes constants (0, 0, 0, C8) into the register R1 in advance. The control circuit 132a also writes constants (C7, C6, C5, C4) into the register R2 in advance. The control circuit 132a also writes constants (C3, C2, C1, C0) into the register R3 in advance. The control circuit 132a writes the value into each register by a set of processing in a program.

The control circuit 132a then executes the high-degree polynomial calculation instruction by a procedure. That is, the control circuit 132a inputs a command “first MCL R0, R2, R1” to the calculating circuit 132c (step S32). The control circuit 132a can thereby control the calculating circuit 132c to perform a calculation by using the values of the vector registers R0, R2, and R1. The calculating circuit 132c thereby reads the values of the vector register R0, the vector register R2, and the vector register R1 from the register 132b. In this case, the calculating circuit 132c reads the value of the vector register R0 by the data path 132d. The calculating circuit 132c also reads the value of the vector register R2 by the data path 132e. The calculating circuit 132c also reads the value of the vector register R1 by the data path 132f.

The calculating circuit 132c calculates “R0.x·R1.w+R0.y·R2.x+R0.z·R2.y+R0.w·R2.z+R2.w”. That is, the calculating circuit 132c multiplies a predetermined combination of the values read by the data path 132d, the values read by the data path 132e, and the values read by the data path 132f, and computes the sum of the products.

The calculating circuit 132c stores the calculation result in the scalar register R1.w of the vector register R1. As a result, the calculation result of “C8·X⁴+C7·X³+C6·X²+C5·X¹+C4” is stored in the scalar register R1.w.

The control circuit 132a inputs the next command to the calculating circuit 132c. The control circuit 132a inputs a command “second MCL R0, R3, R1” to the calculating circuit 132c (step S33). The control circuit 132a can thereby control the calculating circuit 132c to perform a calculation by using the values of the vector registers R0, R3, and R1. That is, the control circuit 132a specifies three vector registers including the vector register having the scalar register in which the calculation result based on the first MCL is written.

The calculating circuit 132c thereby reads the values of the vector register R0, the vector register R3, and the vector register R1 from the register 132b. In this case, the calculating circuit 132c reads the value of the vector register R0 by the data path 132d. The calculating circuit 132c also reads the value of the vector register R3 by the data path 132e. The calculating circuit 132c also reads the value of the vector register R1 by the data path 132f.

The calculating circuit 132c calculates “R0.x·R1.w+R0.y·R3.x+R0.z·R3.y+R0.w·R3.z+R3.w”. The calculating circuit 132c stores the calculation result in the scalar register R1.w of the vector register R1. As a result, the calculation result of “(C8·X⁴+C7·X³+C6·X²+C5·X¹+C4)·X⁴+C3·X³+C2·X²+C1·X¹+C0” is stored in the scalar register R1.w.

This calculation result is C8·X⁸+C7·X⁷+C6·X⁶+C5·X⁵+C4·X⁴+C3·X³+C2·X²+C1·X¹+C0 when expanded. That is, the shader 132j can calculate an eighth-degree polynomial in accordance with two MCLs.

The calculating circuit 132c outputs the value of the scalar register R1.w. That is, the calculating circuit 132c outputs the value of the scalar register R1.w as a pixel value (output data) Y (step S34).

As described above, the shader 132j can compute a high-degree polynomial up to the eighth degree by the two high-degree polynomial calculation instructions. The shader 132j can thereby calculate a high-degree polynomial with a smaller number of steps.

It has heretofore taken much time for a processor to transform a transcendental function into a high-degree polynomial and compute the high-degree polynomial. However, the shader 132j can perform a vector calculation by the calculating circuit 132c. The control circuit 132a can input a command suited to the calculation form in the calculating circuit 132c. Thus, the shader 132j can rapidly calculate a high-degree polynomial. As a result, it is possible to provide a calculating apparatus, a calculating method, and a non-transitory computer-readable storage medium storing computer-executable instructions that enable a more efficient calculation.

Although the control circuit 132a is configured to specify three vector registers in accordance with a command in the embodiment described above, the control circuit 132a is not limited to this configuration. The control circuit 132a may be configured to specify the number of vector registers in accordance with a command. The calculating circuit 132c reads the values of the vector registers specified by the command through the data paths. That is, the shader 132j needs to comprise data paths corresponding to the number of vector registers specified by the command.

Thus, when the number of scalar registers and the number of vector registers specified by the command are increased, the shader 132j can perform a more complex calculation with a smaller number of steps.

Although the control circuit 132a is configured to write (X⁴, X³, X², X¹) into the register R0 in the embodiment described above, the control circuit 132a is not limited to this configuration. The control circuit 132a may be configured to write other values into the register R0. For example, the control circuit 132a may be configured to write (X⁷, X⁵, X³, X¹) into the register R0. In this case, the register 132b is in a state shown in FIG. 8.

That is, the register 132b comprises the vector register R0 having the data (X⁷, X⁵, X³, X¹), the vector register R1 having data on the constants (0, 0, 0, C8), the vector register R2 having data on the constants (C7, C6, C5, C4), and the vector register R3 having data on the constants (C3, C2, C1, C0).

In this case, the shader 132j can also perform calculation processing in the same manner as described above. In this way, the shader 132j can suitably change the calculation configuration.

Although the vector register is configured to have four scalar registers in the embodiment described above, the vector register is not limited to this configuration. The vector register may be configured to have any number of scalar registers. For example, in the embodiment described above, the constants (0, 0, 0, C8) are stored in the vector register R1 in advance. Therefore, if the vector register R1 is configured to store one value, the embodiment described above can be carried out. That is, the vector register R1 may be replaced with scalar registers for storing one value.

Functions described in the above embodiment may be constituted not only with use of hardware but also with use of software, for example, by making a computer read a program which describes the functions. Alternatively, the functions each may be constituted by appropriately selecting either software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A calculating apparatus comprising:
a register module comprising a plurality of registers configured to store a plurality of values;
a controller configured to specify a plurality of registers including a register to which input data is written; and
a calculator configured to calculate a predetermined combination of the values of the specified registers.

2. The calculating apparatus of claim 1, wherein the calculator calculates a predetermined combination of the values of the registers and the values of the different registers.

3. The calculating apparatus of claim 2, wherein the controller specifies the registers by a first command,
the calculator writes, to the register of the register module, a first calculation result based on the register specified by the first command,
the controller specifies, by a second command, the registers including the register to which the first calculation result is written, and
the calculator outputs a second calculation result based on the register specified by the second command.

4. The calculating apparatus of claim 1, wherein the register module comprises
a first register configured to store a value Ra.x, a value Ra.y, a value Ra.z, and a value Ra.w, a second register configured to store a value Rb.x, a value Rb.y, a value Rb.z, and a value Rb.w, and a third register configured to store a value Rc.w, and
the calculator calculates Ra.x·Rc.w+Ra.y·Rb.x+Ra.z·Rb.y+Ra.w·Rb.z+Rb.w when the first register, the second register, and the third register are specified.

5. The calculating apparatus of claim 2, wherein the register module comprises
a first register configured to store a value Ra.x, a value Ra.y, a value Ra.z, and a value Ra.w, a second register configured to store a value Rb.x, a value Rb.y, a value Rb.z, and a value Rb.w, and a third register configured to store a value Rc.w, and
the calculator calculates Ra.x·Rc.w+Ra.y·Rb.x+Ra.z·Rb.y+Ra.w·Rb.z+Rb.w when the first register, the second register, and the third register are specified.

6. The calculating apparatus of claim 3, wherein the register module comprises
a first register configured to store a value Ra.x, a value Ra.y, a value Ra.z, and a value Ra.w, a second register configured to store a value Rb.x, a value Rb.y, a value Rb.z, and a value Rb.w, and a third register configured to store a value Rc.w, and
the calculator calculates Ra.x·Rc.w+Ra.y·Rb.x+Ra.z·Rb.y+Ra.w·Rb.z+Rb.w when the first register, the second register, and the third register are specified.

7. A calculating method of a calculating apparatus which has a register module comprising a plurality of registers configured to store a plurality of values, the method comprising:
specifying a plurality of registers including a register to which input data is written; and
calculating a predetermined combination of the values of the specified registers.

8. A non-transitory computer-readable storage medium storing computer-executable instructions that, when executed, cause the computer which has a register module comprising a plurality of registers configured to store a plurality of values to:
specify a plurality of registers including a register to which input data is written; and
calculate a predetermined combination of the values of the specified registers.
